(19) United States
(12) Patent Application Publication
(10) Pub. No.: US 2018/0345620 A1
(43) Pub. Date: Dec. 6, 2018

(54) CORRUGATED BOARDS WITH SKEWED FLUTES

(71) Applicant: ERNEST PACKAGING SOLUTIONS, Commerce, CA (US)

(72) Inventor: Gary Chao, Brea, CA (US)

(21) Appl. No.: 15/614,351

(22) Filed: Jun. 5, 2017

(51) Int. Cl. B31F 5/08; B31F 1/00

(52) U.S. Cl. CPC B31F 5/085; B31F 1/0016; B31B 3/74; B31B 3/60; B31B 2203/105; B31B 17/60

(57) ABSTRACT

A three dimensional structure made of corrugated board that has at least two flat rectangular surfaces that: are not coplanar; are not parallel; share a common straight edge; and each have multiple, parallel, straight flutes inside of the flat rectangular surface that intersect the common straight edge at an angle that is between 30 and 60 degrees. A corrugator machine that has a configuration that produces corrugated board stock having two parallel, spaced apart outside edges and multiple, parallel, straight flutes inside of the corrugated board stock that intersect each of the outside edges at an angle that is between 30 and 60 degrees.

### TECHNICAL FIELD

This disclosure relates to corrugated boards with flutes, including boxes, trays, displays, and other structures made from them.

### DESCRIPTION OF RELATED ART

Corrugated boards with flutes have been used for about 150 years to protect products, including in boxes, displays, and trays.

Corrugated boards with flutes have been manufactured in much the same way since the late 1800s. A corrugator takes layers of paper, flutes one of the layers, and then glues them together. The resulting corrugated board has flutes that run perpendicular to the direction of material travel.

When converted into trays, boxes, displays, and other structures, these corrugated boards can have limitations. They can have highly inconsistent compression resistance. For example, the compression resistance of a 200# bursting test board made of these corrugated boards can range from 600-800 pounds. To accommodate for this range, manufacturers may need to build a box or tray product for the highest possible level of compression resistance.

Multiple layers of fluted material may need to be sandwiched together to build boxes that will consistently have the needed strength in view of this variability. More complex box designs may also be needed. These additional materials and complications can make the box more expensive.

The corrugated boards may also only be able to be trimmed in one direction to preserve the integrity of the corrugate. This can limit the ability to manufacture custom sizes or shapes from corrugated boards. Most corrugators run at a 98-inch width. While some manufacturers have corrugators that run from 110 up to 130 inches, these are less common. As a result, any design that requires wider blanks, may need to use multiple sheets of board.

Likewise, scoring boxes can be challenging. Scoring can determine where the folds go. Because the fluting lines may not be perfectly straight, the variance may affect the scoring. When scoring, there is also a risk that the flute will roll left or right, causing inaccuracies in the placement of the score. As a result, today's automated box erector machines can suffer from as much as a ⅛th inch scoring variance. This variance can cause inconsistencies in the dimensions of the boxes that are produced. As the corrugated board runs through a machine's rails, this tolerance variation can cause the corrugated board to be either too loose or too tight in the machine, which can even result in a jam.

### SUMMARY

A three dimensional structure may be made of corrugated board that has at least two flat rectangular surfaces that: are not coplanar; are not parallel; share a common straight edge; and each have multiple, parallel, straight flutes inside of the flat rectangular surface that intersect the common straight edge at an angle that is between 30 and 60 degrees.

The angle may be between 40 and 50 degrees or 44 and 46 degrees.

The structure may be a box having six flat rectangular surfaces that: each share four common straight edges with a different one of the other flat surfaces; and each have multiple, parallel, straight flutes inside of the flat rectangular surface that intersect each of its four common straight edges at an angle that is between 30 and 60 degrees.

A corrugator machine may have a configuration that produces corrugated board stock having two parallel, spaced apart outside edges and multiple, parallel, straight flutes inside of the corrugated board stock that intersect each of the outside edges at an angle that is between 30 and 60 degrees.

The corrugator machine may include a flute roller that produces the flutes, that has an axis of rotation, and that has a roller surface that includes a set of parallel flute indentations that form an angle with respect to the axis of rotation that is between 30 and 60 degrees.

The flute roller may be a first flute roller. The corrugator machine may include a second flute roller that cooperates with the first flute roller to produce the flutes, that has an access of rotation that is parallel to the axis of rotation of the first flute roller, and that has a roller surface that includes a set of parallel flute indentations that form an angle with respect to the axis of rotation of the second flute roller that is between 30 and 60 degrees.

The angle may be between 40 and 50 degrees or 44 and 46 degrees.

The corrugator machine may include a flute roller that produces the flutes, that has an axis of rotation, and that has a roller surface that includes a set of parallel flute indentations that form an angle with respect to the axis of rotation that is between 40 and 50 degrees.

The flute roller may be a first flute roller. The corrugator machine may include a second flute roller that cooperates with the first flute roller to produce the flutes, that has an access of rotation that is parallel to the axis of rotation of the first flute roller, and that has a roller surface that includes a set of parallel flute indentations that form an angle with respect to the axis of rotation of the second flute roller that is between 40 and 5 degrees.

The corrugator machine of claim 13 further comprising a flute roller that produces the flutes, that has an axis of rotation, and that has a roller surface that includes a set of parallel flute indentations that form an angle with respect to the axis of rotation that is between 30 and 60 degrees.

The corrugator machine of claim 14 wherein the flute roller is a first flute roller and where the corrugator machine further comprises a second flute roller that cooperates with the first flute roller to produce the flutes, that has an access of rotation that is parallel to the axis of rotation of the first flute roller, and that has a roller surface that includes a set of parallel flute indentations that form an angle with respect to the axis of rotation of the second flute roller that is between 30 and 60 degrees.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a prior art box having six flat rectangular surfaces, three of which are visible. Each rectangular surface has multiple, parallel, straight flutes inside of the rectangular surface that intersect two edges of the rectangular surface at an angle of 90 degrees and that are parallel to two other edges of the rectangular surface.

FIG. 2 illustrates an example of a box having six flat rectangular surfaces, three of which are visible. Each rectangular surface has multiple, parallel, straight flutes inside of the rectangular surface that intersect all of the edges of the rectangular surface at an angle of 45 degrees.

FIG. 3 illustrates an example of a display structure with multiple, parallel, straight flutes inside of a rectangular surface of the display that intersect all of the edges of the rectangular surface at an angle of 45 degrees.

FIG. 4 illustrates an example of portions of a corrugator machine that produces corrugated board stock having two parallel, spaced apart outside edges and multiple, parallel, straight flutes inside of the corrugated board stock that intersect each of the outside edges at a 45 degree angle.

FIG. 5 illustrates an enlarged and perspective view of two flute rollers that are illustrated in FIG. 4 impressing parallel, straight flutes on flute material stock that is being passed between the two flute rollers at an angle of 45 degrees with respect to sides of the sheet material.

FIG. 6 illustrates an enlarged side view of the rollers 413 and 415 and the flutes that they impress on the flute material stock 403.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

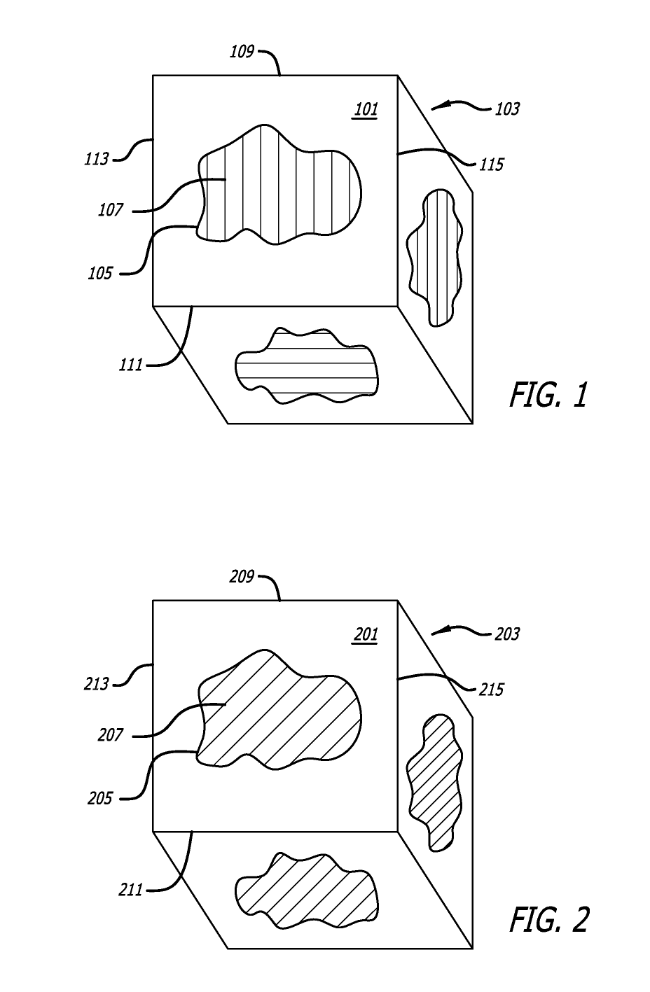

FIG. 1 illustrates an example of a prior art box 103 having six flat rectangular surfaces, three of which are visible. Each rectangular surface has multiple, parallel, straight flutes inside of the rectangular surface that intersect two edges of the rectangular surface at an angle of 90 degrees and that are parallel to two other edges of the rectangular surface. One example is rectangular surface 101 with cut-away 105 that exposes straight flutes 107 inside of the rectangular surface 101 that intersect two edges 109 and 111 of the rectangular surface 101 at an angle of 90 degrees and that are parallel to two other edges 113 and 115 of the rectangular surface 101. The box 103 may be made by folding a single, flat corrugated board into the shape of the box 103. Two opposing rectangular surfaces of the box 103 may consist of flaps which may be closed and sealed together, thereby completing the formation of the box 103. The box 103 may have any dimensions.

FIG. 2 illustrates an example of a box 203 having six flat rectangular surfaces, three of which are visible. Each rectangular surface has multiple, parallel, straight flutes inside of the rectangular surface that intersect all of the edges of the rectangular surface at an angle of 45 degrees. One example is rectangular surface 201 with cut-away 205 that exposes a portion of multiple, parallel, straight flutes 207 inside of the rectangular surface 201 that intersect all of the edges 209, 211, 213, and 215 of the rectangular surface 201 at an angle of 45 degrees.

The box 203 may be made by folding a single flat corrugated board into the shape of the box 203. Two opposing surfaces of the box 203 may consist of flaps which may be closed and sealed together, thereby completing the formation of the box 203. The box 203 may have any dimensions.

The angles of intersection may not be precisely 45 degrees. For examples, the angles of intersection may be between 44 and 46 degrees, between 40 and 50 degrees, or between 30 and 60 degrees.

Each surface of the box 203 may include a set of multiple, parallel, straight flutes. A flat sheet of material may be attached to one or both sides of the flutes with glue or other adhesive. One or more surfaces of the box may instead comprise a sandwich of multiple flute layers, separated from one another by one or more flat layers of material, all of the layers being attached to one another by glue or another adhesive. The adhesive may be applied to more than one layer of flute, such as in double wall, triple wall or quad wall corrugated sheets. The multiple layers of the flutes sandwiched between each layer of liner may be running in parallel or perpendicular to each layer of the flutes. Corrugators running multiple wall sheets may require multiple angle flute wheels.

The box 203 may be made for any material, such any type of pulp material currently being produced by paper mills, and can be manufactured off a corrugator. Examples include, but are not limited to, Kemi, poster stock, sbs, kraft, #3w and #1w corrugated paper stock.

Other three dimensional structures with rectangular surfaces may be made from corrugated board of any of these materials having flutes with the same described angles with respect to the edges of the rectangular surfaces, such as displays and trays.

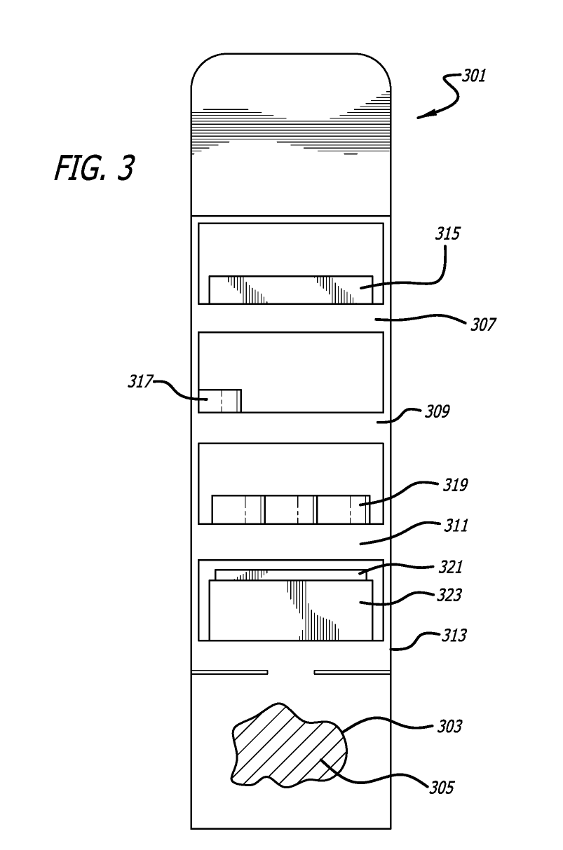

FIG. 3 illustrates an example of a display structure 301 with a cut-away 303 that exposes a portion of multiple, parallel, straight flutes 305 inside of a rectangular surface of the display that intersect all of the edges of the rectangular surface at an angle of 45 degrees. As illustrated in FIG. 3, the display may include multiple rectangular shelves 307, 309, 311 and 313 that may hold various articles, such as articles 315, 317, 319, 321 and 323. Some or all of the other rectangular surfaces of the display structure 301 may similarly include multiple, parallel, straight flutes inside of the rectangular surface that intersect all of the edges of the rectangular surface at an angle of 45 degrees.

The types of material from which the display structure 301 is made, as well as the angles between the flutes and the side edges of the rectangular surfaces in which they exist may be subject to all of the variations that are discussed above in connection with the box and flutes illustrated in FIG. 2.

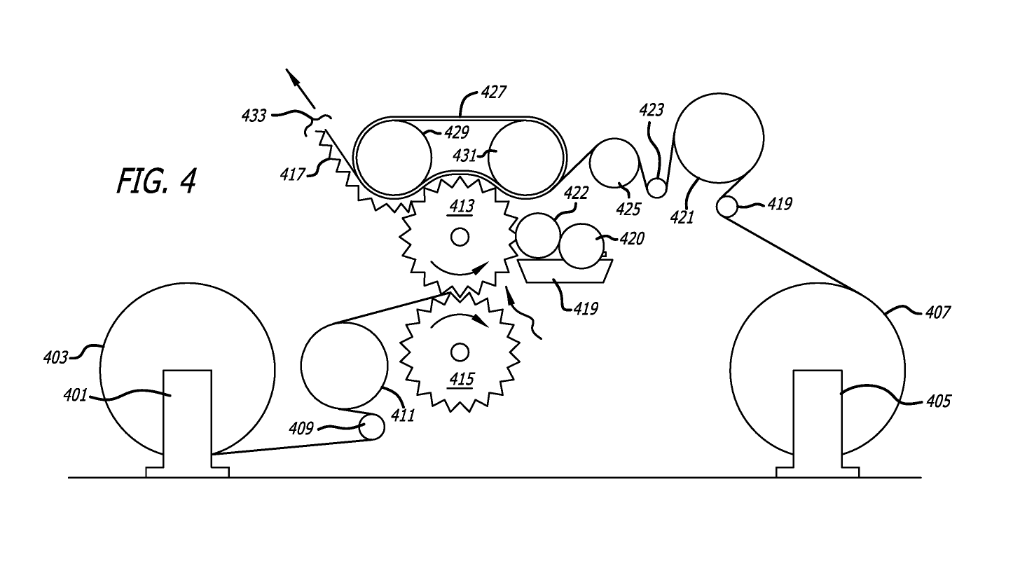

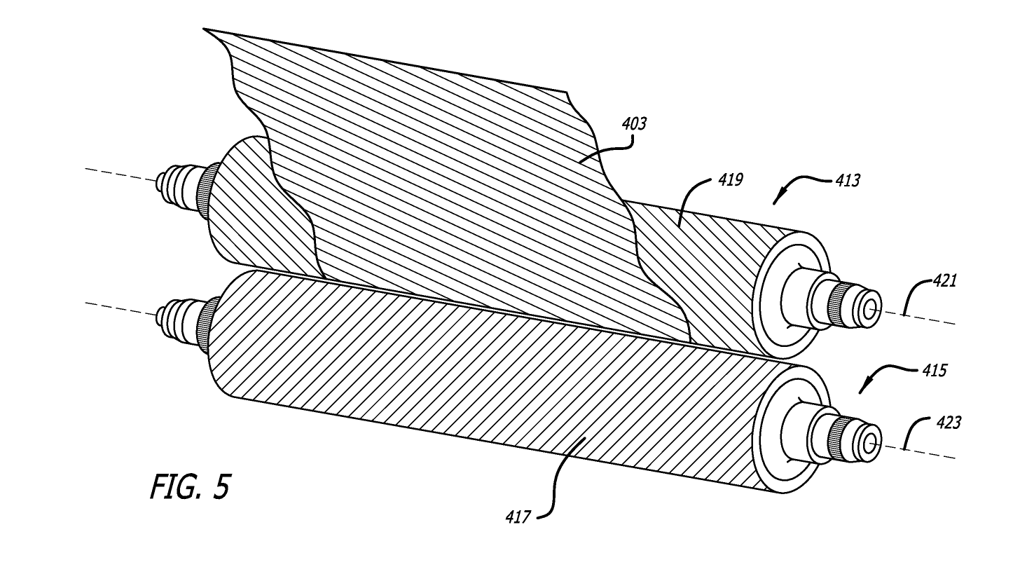

FIG. 4 illustrates an example of portions of a corrugator machine that produces corrugated board stock having two parallel, spaced apart outside edges and multiple, parallel, straight flutes inside of the corrugated board stock that intersect each of the outside edges at a 45 degree angle. As illustrated in FIG. 4, the corrugator machine may include a flute material stock holder 401 that holds a roll of flute material stock 403, and an outer surface material stock holder 405 that holds a roll of outer surface material stock 407.

Feed rollers 409 and 411 may be used to draw and direct the flute material stock 403 into flute rollers 413 and 415. Flute rollers 413 and 415 may rotate in opposite directions and may impress onto the flute material stock 403 a series of multiple, parallel flutes 417 as the flute material stock travels through and is compressed by the flute rollers 413 and 415. The resulting flutes may form an angle of 45 degrees or an angle between 44 and 46 degrees, 40 and 50 degrees, or 30 and 60 degrees, with respect to parallel outer edges of the flute material stock 403.

The outer surface material stock 407 may similarly be drawn and directed by rollers 419, 421, 423, and 425.

A adhesive material pan 419 may hold uncured adhesive material, such as glue. Rollers 420 and 422 may be used to transfer and apply this adhesive to a surface of the flute material stock 403.

After the flutes are formed in and adhesive is applied to the flute material stock 403, the flute material stock 403 may be attached to the outer surface material 407 by pressing the outer surface material stock against the side of the flute material stock 403 that has had adhesive applied to it. This may be done, for example, by a pressure belt 427 that is caused to rotate by rollers 429 and 431.

The resulting flute and flat material stock 433 may then go through another station (not shown) that may attach another flat outer surface to the other side of the flute material stock 433, thereby completing the manufacture of the fluted corrugate board.

The final corrugated board stock may have two parallel, spaced apart outer edges and multiple, parallel, straight flutes inside of the corrugated board stock that intersect each of the outer edges of the corrugated board stock at a 45 degree angle, or an angle that is between 40 and 46 degrees, 40 and 50 degrees, or 30 and 60 degrees.

The resulting corrugated board stock may then be cut, scored, and folded by the corrugator machine or by another machine to produce boxes, displays, trays of and other types of three dimensional structures of desired sizes.

FIG. 5 illustrates an enlarged and perspective view of the two flute rollers 413 and 415 that are illustrated in FIG. 4 impressing parallel, straight flutes on the flute material stock 403 that is being passed between the two flute rollers 413 and 415. The impressed flutes may be at an angle of 45 degrees with respect to sides of the corrugated material stock, or at an angle between 44 and 46 degrees, 40 and 50 degrees, or 30 and 60 degrees. Each of the flute rollers 413 and 415 may include a roller surface 417 and 419, respectively, that each may include a set of parallel flute protrusions and indentations that form an angle with respect to the axis of rotation 421 and 423 of the flute rollers 413 and 415, respectively, that is 45 degrees or between 44 and 46 degrees, 40 and 50 degrees, or 30 and 60 degrees. The parallel flute protrusion and indentations in one roller may be aligned with the parallel flute protrusions and indentations in the other roller so that all of the flute protrusions and indentations fully mash within one another as the rollers synchronously rotate in opposite directions. This may insure that flutes are firmly impressed into the flute material stock 403. In the wet end of a corrugator, flute material may be being heated and steamed to soften into a required valley and peak shape.

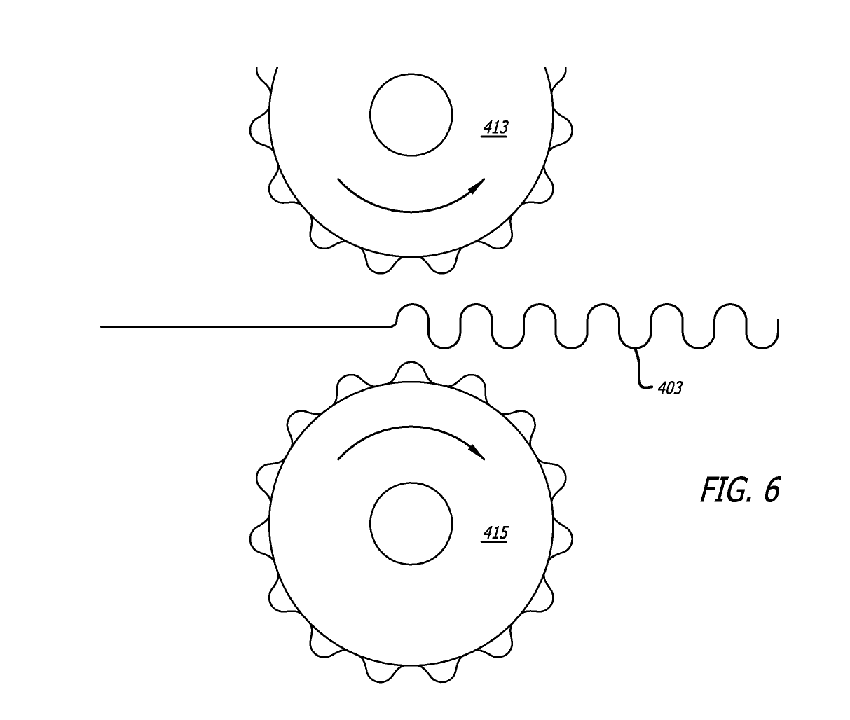

FIG. 6 illustrates and enlarged side view of the rollers 413 and 415 and the flutes that they impress on the flute material stock 403. The rollers 413 and 415 are illustrated as being separated. As explained above, however, the protrusions and indentations in the surfaces of the rollers are tightly intermeshed during operation to maximize their effectiveness.

By way of summary, the direction of the corrugated flutes has been changed from the prior art approach of being parallel and perpendicular to the side edges to being at 45 degrees, between 44 and 46 degrees, between 40 and 50 degrees, or between 30 and 60 degrees. Placing the flutes at such an angle may improve compression resistance and maximize manufacturing flexibility.

These angles may also give the produced corrugated board more consistent compression. These angles may facilitate transferring top-to-bottom compression motion in a circular direction giving it rotational force resistance. For example, a 45-degree angle may deliver consistently improved compression resistance with much tighter tolerances. Box, tray, and display manufacturers may therefore be able to use lighter weight paper, reducing the basis weight and materials cost of the final products. This approach may also provide greater product consistency, which may minimize the need to overbuild final manufactured designs to protect within tolerances. This can offer as much as a 15% materials savings for many designs.

Boxes built with angle-fluted corrugate may also provide consistent stacking protection, no matter what direction the boxes are stacked. Today, manufacturers may require boxes to be stacked with flutes running vertically to maximize compression resistant performance. This can be challenging when using third-party shipping resources, as the manufacturer may have no control over how boxes are stacked or the resulting protection of their product.

These flute angles may also offer manufacturers significantly greater flexibility in production. Boards can be trimmed by either flute direction of the blank (vertically or horizontally), without any change in compression capabilities. This may reduce waste and may allow corrugated manufacturers to customize board sizes and maximize production efficiencies by combo-trimming on the same corrugator. These flute angles may also simplify ordering of corrugated product. Today, sheets may need to be ordered by specifying the direction of vertical fluting (e.g., 24″×10″). With fluting at a 45 degree angle, these measurements may become irrelevant, as the strength is the same no matter how the end product is constructed.

Corrugated boards with skewed angled fluting may also improve scoring and automated box building. By eliminating the risk of flutes rolling during scoring, this new design may also eliminate the need for perforated scoring, which can weaken the material. As a result, box manufacturers may no longer have to perform secondary passes, which may take a step out of the manufacturing process and may save an average of 25% of the cost. More accurate scoring may also enable automated erector systems to have significantly tighter tolerances (vs. ⅛th-inch standard today). This may reduce machine jamming for more efficient manufacturing and may ensure that finished boxes are exactly the size intended.

As for printability, there may be no difference in the print quality obtainable with this new fluting direction. In addition, there may be no difference in the cutting die/steel rule application. Both of these factors may remain consistent with current specifications.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, when the angle of the flutes is 45 degrees, this application may be able to be used on any corrugator, regardless of its flute cylinder diameter or width. A 45-degree angle may meet up at the end of one revolution to the beginning of a new revolution, to create a continuous flute impression on the flute material. Creating multiple wall corrugated sheets, having each layer of the flute running perpendicular to the adjacent flute direction, may add additional structural integrity.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A three dimensional structure made of corrugated board that has at least two flat rectangular surfaces that:
are not coplanar;
are not parallel;
share a common straight edge; and
each have multiple, parallel, straight flutes inside of the flat rectangular surface that intersect the common straight edge at an angle that is between 30 and 60 degrees.

2. The three-dimensional object of claim 1 wherein the angle is between 40 and 50 degrees.

3. The three-dimensional object of claim 2 wherein the angle is between 44 and 46 degrees.

4. The three-dimensional structure of claim 1 wherein the structure is a box having six flat rectangular surfaces that:
each share four common straight edges with a different one of the other flat surfaces; and
each have multiple, parallel, straight flutes inside of the flat rectangular surface that intersect each of its four common straight edges at an angle that is between 30 and 60 degrees.

5. The three-dimensional object of claim 4 wherein the angle is between 40 and 50 degrees.

6. The three-dimensional object of claim 5 wherein the angle is between 44 and 46 degrees.

7. A corrugator machine that has a configuration that produces corrugated board stock having two parallel, spaced apart outside edges and multiple, parallel, straight flutes inside of the corrugated board stock that intersect each of the outside edges at an angle that is between 30 and 60 degrees.

8. The corrugator machine of claim 7 further comprising a flute roller that produces the flutes, that has an axis of rotation, and that has a roller surface that includes a set of parallel flute indentations that form an angle with respect to the axis of rotation that is between 30 and 60 degrees.

9. The corrugator machine of claim 8 wherein the flute roller is a first flute roller and where the corrugator machine further comprises a second flute roller that cooperates with the first flute roller to produce the flutes, that has an access of rotation that is parallel to the axis of rotation of the first flute roller, and that has a roller surface that includes a set of parallel flute indentations that form an angle with respect to the axis of rotation of the second flute roller that is between 30 and 60 degrees.

10. The corrugator machine of claim 7 wherein the angle is between 40 and 50 degrees.

11. The corrugator machine of claim 10 further comprising a flute roller that produces the flutes, that has an axis of rotation, and that has a roller surface that includes a set of parallel flute indentations that form an angle with respect to the axis of rotation that is between 40 and 50 degrees.

12. The corrugator machine of claim 11 wherein the flute roller is a first flute roller and where the corrugator machine further comprises a second flute roller that cooperates with the first flute roller to produce the flutes, that has an access of rotation that is parallel to the axis of rotation of the first flute roller, and that has a roller surface that includes a set of parallel flute indentations that form an angle with respect to the axis of rotation of the second flute roller that is between 40 and 5 degrees.

13. The corrugator machine of claim 8 wherein the angle is between 44 and 46 degrees.

14. The corrugator machine of claim 13 further comprising a flute roller that produces the flutes, that has an axis of rotation, and that has a roller surface that includes a set of parallel flute indentations that form an angle with respect to the axis of rotation that is between 30 and 60 degrees.

15. The corrugator machine of claim 14 wherein the flute roller is a first flute roller and where the corrugator machine further comprises a second flute roller that cooperates with the first flute roller to produce the flutes, that has an access of rotation that is parallel to the axis of rotation of the first flute roller, and that has a roller surface that includes a set of parallel flute indentations that form an angle with respect to the axis of rotation of the second flute roller that is between 30 and 60 degrees.
